(19) United States
(12) Patent Application Publication
(10) Pub. No.: US 2025/0382039 A1
(43) Pub. Date: Dec. 18, 2025

(54) DYNAMIC MINIMUM AND MAXIMUM WATER DEPTH VALUE ESTIMATION SYSTEMS AND METHODS

(71) Applicant: NAVICO GROUP AMERICAS, LLC, Menomonee Falls, WI (US)

(72) Inventor: Leigh Armstrong, Auckland (NZ)

(21) Appl. No.: 18/743,493

(22) Filed: Jun. 14, 2024

(51) Int. Cl. B63B 49/00; B63B 79/15; G01C 21/20

(52) U.S. Cl. CPC B63B 49/00; B63B 79/15; G01C 21/20

(57) ABSTRACT

A system for determining minimum and maximum water depth value at a location on a body of water is provided. The system utilizes various data sources, including historical and community-sourced data, environmental data, geographical data, and sensor data, to provide an accurate and dynamic estimation of the minimum and maximum water depth value. By considering multiple factors affecting water depth, such as tides, and weather conditions, the system enables safer navigation. Users can input a location and receive the minimum and maximum water depth value, which is continuously updated based on the latest available data. The system also facilitates route planning by determining the minimum water depth values along a route and providing alerts when necessary, allowing users to make informed decisions and navigate safely. By leveraging diverse data sources, the system provides a comprehensive and reliable solution for determining minimum and maximum water depth values compared to existing systems.

### FIELD OF THE INVENTION

Embodiments of the present invention relate generally to systems for determining a minimum water depth value and maximum water depth value at a location on a body of water. More specifically, the invention relates to a system that utilizes various data sources to provide an accurate and dynamic estimation of the minimum water depth value and maximum water depth value at a specific location, enabling safer navigation, informed decision-making, and enhanced anchoring assistance on bodies of water.

### BACKGROUND OF THE INVENTION

Safe navigation on bodies of water requires accurate knowledge of water depth, particularly the minimum water depth value, at various locations. Insufficient water depth can lead to grounding or collision with underwater obstacles, potentially causing damage to the watercraft, injury to passengers, and environmental harm. Traditional methods of determining water depth rely on charts that may be outdated or may not account for dynamic factors that affect water depth, such as tides, weather conditions, and changes in the underwater landscape.

Existing systems for determining water depth value often rely solely on data from onboard sensors, such as sonar or depth finders. While these sensors provide real-time data, they are limited to the immediate location of the watercraft and do not account for variations in water depth, such as due to wave action. Additionally, these systems do not incorporate historical data or data from other sources that could provide a more comprehensive understanding of water depth patterns and trends.

Furthermore, when planning a route between two locations on a body of water, current systems do not provide a way to determine the minimum water depth value along the entire route. This lack of information can lead to the selection of a route that may not be safe for the watercraft, given its draft and other characteristics.

Moreover, existing systems often fail to account for the maximum water depth value, which represents the maximum depth a watercraft may encounter at a given location due to tides and waves. This information may be used in activities such as anchoring, where the anchor line length must be sufficient to ensure a secure hold even at the highest water levels. Without considering the maximum water depth value, watercraft operators may not have the necessary information to make informed decisions about anchoring and other depth-related aspects of navigation.

There is a need for a system that can provide a more accurate and dynamic estimation of minimum water depth value and maximum depth value at a location by leveraging multiple data sources, including historical and community-sourced data, environmental data, geographical data, and sensor data. Such a system would enable safer navigation by providing watercraft operators with a more comprehensive understanding of water depth conditions and trends, and by facilitating the selection of routes that are optimized for safe passage based on the watercraft's requirements and the minimum water depth value along the route.

### BRIEF SUMMARY OF THE INVENTION

Systems and methods are provided for determining and displaying the minimum water depth value and maximum water depth value at a location on a body of water. The system utilizes various data sources, including historical and community-sourced data, geographical data, environmental data, sensor data, and other relevant information, to provide an accurate and up-to-date estimation of the minimum water depth value and maximum water depth value. The system may be connected to one or more processors and a display device, such as a marine electronic device, to process the data and present the minimum water depth value and maximum water depth value information to the user.

A user may input a specific location of interest and/or certain parameters, and the processor(s) may work to determine the minimum water depth value and maximum water depth value at that location with a high degree of precision. The system may retrieve and analyze data from various sources to account for factors such as tides, weather conditions, underwater features, and real-time sensor measurements. By considering multiple data points and employing advanced data processing techniques, such as machine learning algorithms, the system can generate accurate predictions and estimates of the minimum water depth value and maximum water depth value, tailored to the user's specific needs and the characteristics of their watercraft.

Various embodiments described herein provide improvements to technology, allowing a user to obtain reliable and precise minimum water depth and maximum water depth information with limited input required from the user. By integrating and analyzing data from multiple sources in real-time, the system can perform tasks that cannot practically be performed within the human mind. For example, the system can process vast amounts of data, identify patterns and relationships, and update the minimum water depth value simultaneously and in real-time based on changing conditions. Where users attempt to estimate the minimum water depth value and maximum water depth value manually, they may not have access to the same breadth and depth of data, and they may not be capable of making calculations and adjustments in real-time to maintain the same level of accuracy and precision that can be achieved using the described system. Embodiments described herein provide improvements to the user experience by delivering reliable, up-to-date, and precise minimum water depth and maximum water depth information, enabling users to make informed decisions and navigate safely. The system can automatically adjust its calculations and update the displayed information based on new data, ensuring that the minimum water depth value and maximum water depth value remains accurate even in dynamic and changing environmental conditions. Furthermore, the system may reduce the cognitive load on the user, allowing them to focus on other tasks such as navigation, fishing, or leisure activities, while still having access to critical safety information.

In an example embodiment, a system for determining a minimum water depth value at a location on a body of water is provided. The system comprises at least one processor, a display, and a memory operatively connected to the at least one processor. The memory operatively connected to the at least one processor comprises computer executable instructions that, when executed by the at least one processor, causes the processor to receive user input indicating a location on the body of water and determine a water depth value associated with the location. The computer executable instructions are also configured to cause the processor to determine a minimum water depth value for the location based at least in part on one or more of: historical data and community-sourced data, environmental data, geographical data, or sensor data; and cause, on the display, presentation of the minimum water depth value.

In some embodiments, the system for determining a minimum water depth value further comprises a data retrieval module executed by the processor. The data retrieval module is configured to access external data sources to gather at least one of: the historical data and community-sourced data, the environmental data, the geographical data, or the sensor data.

In some embodiments, the computer executable instructions of the system for determining a minimum water depth value further causes the processor to receive user input specifying a starting location and a destination location. The computer executable instruction also causes the processor to determine a minimum route depth. The computer executable instruction also causes the processor to determine a potential route that is optimized for safe navigation based on the minimum water depth value between the starting location and the destination location. The computer executable instruction further causes the processor to cause presentation of the potential route.

In some embodiments, the system determines the potential route, wherein determining the potential route comprises accessing data associated with the potential route from one or more external data sources. Furthermore, determining the potential route also comprises analyzing the accessed data to determine a set of minimum water depth values corresponding to the potential route. Also, determining the potential route comprises comparing the set of minimum water depth values to the minimum route depth. Additionally, determining the potential route comprises selecting the potential route based on the comparison indicating that the set of minimum water depth values meets the minimum route depth.

In some embodiments, the computer executable instructions of the system for determining a minimum water depth value further causes the processor to monitor the minimum water depth value at locations along the potential route over time. Furthermore, the computer executable instructions cause the processor to generate an alert when the minimum water depth value falls below the minimum route depth. Additionally, the computer executable instructions cause the processor to cause, on the display, presentation of the alert.

In some embodiments, the system for determining a minimum water depth value includes causing presentation of the minimum water depth value on the display. The presentation of the minimum water depth value on the display comprises rendering of a graphical representation of the body of water with the location indicated and presenting the minimum water depth value in association with the location.

In some embodiments, the computer executable instructions of the system for determining a minimum water depth value further causes the processor continuously to monitor for updates to the minimum water depth value for the location. Furthermore, the computer executable instructions cause the processor to adjust the presentation of the minimum water depth value on the display as updated values are received.

In some embodiments, the historical data and community-sourced data of the system for determining a minimum water depth value comprises aggregated water depth data derived from a plurality of measurements recorded at a location over time.

In some embodiments, the environmental data of the system for determining a minimum water depth value comprises data representing one or more environmental factors that influence water depth at the location.

In some embodiments, the geographical data of the system for determining a minimum water depth value comprises data representing physical characteristics of the body of water and surrounding areas.

In some embodiments, the sensor data of the system for determining a minimum water depth value comprises a plurality of depth related measurements obtained from one or more sensors.

In another example embodiment, a marine electronic device for determining a minimum water depth value at a location on a body of water is provided. The device comprises at least one processor, a display, and a memory operatively connected to the at least one processor. The memory operatively connected to the at least one processor comprises computer executable instructions that, when executed by the at least one processor, causes the processor to receive user input indicating a location on the body of water and determine a water depth value associated with the location. The computer executable instructions are also configured to cause the processor to determine a minimum water depth value for the location based at least in part on one or more of: historical data and community-sourced data, environmental data, geographical data, or sensor data; and cause, on the display, presentation of the water depth value and the minimum water depth value.

In some embodiments, the at least one processor of the marine electronic device for determining a minimum water depth value is further configured to access external data sources to gather at least one of: the historical data and community-sourced data, the environmental data, the geographical data, or the sensor data.

In some embodiments, the computer executable instructions of the marine electronic device for determining a minimum water depth value causes the processor to receive user input specifying a starting location, wherein the starting location is a destination location. The computer executable instruction further causes the processor to determine a minimum route depth corresponding to a potential route between the starting location and the destination location. Additionally, the computer executable instructions cause the processor to determine the potential route based on the minimum water depth value at locations between the starting location and the destination location. Furthermore, the computer executable instructions cause the processor to cause presentation of the potential route.

In some embodiments, the marine electronic device for determining a minimum water depth value is further configured to determine a potential route. Where determining the potential route comprises determining a set of minimum water depth values corresponding to the potential route. Furthermore, determining the potential route comprises comparing the set of minimum water depth values to the minimum route depth. Additionally, determining the potential route comprises selecting the potential route based on the comparison indicating that the set of minimum water depth values meets the minimum route depth.

In some embodiments, the computer executable instructions of the marine electronic device for determining a minimum water depth value further causes the processor to monitor the minimum water depth value at locations along the potential route over time. Furthermore, the computer executable instructions cause the processor to generate an alert when the minimum water depth value falls below the minimum route depth. Additionally, the computer executable instructions cause the processor to cause, on the display, presentation of the alert.

In some embodiments, the marine electronic device for determining a minimum water depth value causes presentation of the minimum water depth value on the display. The presentation of the minimum water depth value on the display comprises rendering of a graphical representation of the body of water with the location indicated and presenting the minimum water depth value in association with the location.

In some embodiments, the computer executable instructions of the marine electronic device for determining a minimum water depth value further causes the processor continuously to monitor for updates to the minimum water depth value for the location. Furthermore, the computer executable instructions cause the processor to adjust the presentation of the minimum water depth value on the display as updated values are determined.

In another example embodiment, a method for determining a minimum water depth at a location on a body of water is provided. The method comprises receiving, by at least one processor, user input indicating a location on the body of water. The method also includes retrieving, by a data retrieval module executed by the at least one processor, data from one or more external data sources. The method also includes determining, by at least one processor, a minimum water depth value for the location based at least in part on data retrieved from the one or more external data sources by the data retrieval module. The method also includes causing, by the at least one processor, a display to present the minimum water depth value. The method further includes updating, by the at least one processor, the displayed minimum water depth value based on the data retrieved from the one or more external data sources.

In some embodiments, the data retrieval module of the method for determining a minimum water depth at a location on a body of water is configured to access the one or more external data sources. The data retrieval module accesses the one or more external data sources to gather at least one of: historical data and community-sourced data, environmental data, geographical data, or sensor data.

In another example embodiment, a system for determining a maximum water depth value at a location on a body of water is provided. The system comprises at least one processor, a display, and a memory operatively connected to the at least one processor. The memory operatively connected to the at least one processor comprises computer executable instructions that, when executed by the at least one processor, causes the processor to receive user input indicating a location on the body of water and determine a water depth value associated with the location. The computer executable instructions are also configured to cause the processor to determine a maximum water depth value for the location based at least in part on one or more of: historical data and community-sourced data, environmental data, geographical data, or sensor data; and cause, on the display, presentation of the maximum water depth value.

In some embodiments, the computer executable instructions of the system for determining a maximum water depth value further causes the processor to determine, based on the maximum water depth value, one or more safe anchoring locations within a predetermined vicinity of the location.

In some embodiments, the computer executable instructions of the system for determining a maximum water depth value further causes the processor to cause on the display, presentation of the one or more safe anchoring locations. The computer executable instructions also cause the processor to provide, on the display, visual guidance indicating a suggested anchor line length for each of the one or more safe anchoring locations based on the maximum water depth value.

In some embodiments, the computer executable instructions of the system for determining a maximum water depth value further causes the processor to determine a minimum water depth value for the location. The computer executable instructions also causes the processor to cause, on the display, presentation of the minimum water depth value in conjunction with the maximum water depth value to provide a range of water depths at the location.

In some embodiments, the sensor data of the system for determining a maximum water depth value includes wave height data, wherein determining the maximum water depth value comprises adding a wave height value to the water depth value.

### BRIEF DESCRIPTION OF THE DRAWINGS

Having thus described the invention in general terms, reference will now be made to the accompanying drawings, which are not necessarily drawn to scale, and wherein:

FIG. 1 illustrates a side view of an example watercraft including various marine devices, in accordance with some embodiments discussed herein;

FIG. 2A is a schematic view illustrating the watercraft positioned on a body of water and a separate outline of the watercraft situated at the trough of a wave to represent the actual difference in water depth-showing, e.g., the minimum water depth value, in accordance with some embodiments discussed herein;

FIG. 2B is a schematic view illustrating the watercraft positioned on a body of water and a separate outline of the watercraft situated at the peak of a wave to represent the actual difference in water depth-showing, e.g., the maximum water depth value, in accordance with some embodiments discussed herein;

FIG. 3 is a schematic view illustrating example map data depicting a watercraft with standard water depth values, in accordance with some embodiments discussed herein;

FIG. 4 is a schematic view illustrating example map data depicting a watercraft with minimum water depth values, in accordance with some embodiments discussed herein;

FIG. 5 is a schematic view illustrating example map data and a navigational path for the watercraft that positions the watercraft at locations maintaining safe minimum water depth values, in accordance with some embodiments discussed herein;

FIG. 6 is a schematic view illustrating an example display presenting selection options for the user to choose a desired mode of operation, such as fishing, in accordance with some embodiments discussed herein;

FIG. 7 is a block diagram illustrating an example system comprising various electronic devices, marine devices, and secondary devices, in accordance with some embodiments discussed herein; and

FIG. 8 is a flow chart illustrating an example method for determining a minimum water depth value at a location on a body of water, in accordance with some embodiments discussed herein.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals generally refer to like elements throughout. Additionally, any connections or attachments may be direct or indirect connections or attachments unless specifically noted otherwise. Further, the embodiments included below are not necessarily drawn to scale.

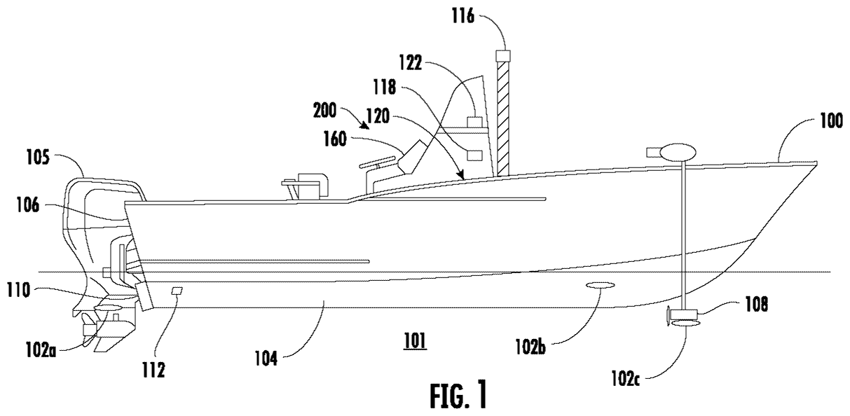

FIG. 1 illustrates an example watercraft 100 including various marine devices that are part of a system 200 for determining a minimum water depth value and a maximum water depth value, in accordance with some embodiments discussed herein. As depicted in FIG. 1, the watercraft 100 (e.g., a vessel) configured to traverse a marine environment, e.g., body of water 101, and may use one or more sonar transducer assemblies 102a, 102b, and 102c disposed on and/or proximate to the watercraft 100. Notably, example watercraft 100 contemplated herein may be surface watercraft, submersible watercraft, or any other implementation known to those skilled in the art. The sonar transducer assemblies 102a, 102b, and 102c may each include one or more sonar transducer elements configured to transmit sound waves into the body of water 101, receive sonar returns from the body of water 101, and convert the sonar returns into sonar return data that may be utilized by the system 200 to determine a minimum water depth value and a maximum water depth value at a location on the body of water 101. Various types of sonar transducers may be provided—for example, a linear downscan sonar transducer, a conical downscan sonar transducer, a sonar transducer array, or a sidescan sonar transducer may be used.

Depending on the configuration, the watercraft 100 may include a primary motor 105, which may be a main propulsion motor such as an outboard or inboard motor. Additionally, the watercraft 100 may include a trolling motor 108 configured to propel the watercraft 100 or maintain a position. The one or more sonar transducer assemblies (e.g., 102a, 102b, and/or 102c) may be mounted in various positions and to various portions of the watercraft 100 and/or equipment associated with the watercraft 100. For example, the sonar transducer assembly may be mounted to the transom 106 of the watercraft 100, such as depicted by sonar transducer assembly 102a. The sonar transducer assembly may be mounted to the bottom or side of the hull 104 of the watercraft 100, such as depicted by sonar transducer assembly 102b. The sonar transducer assembly may be mounted to the trolling motor 108, such as depicted by transducer assembly 102c.

The watercraft 100 may also include one or more marine electronic devices 160, which may be part of a system 200 for determining the minimum water depth value and maximum water depth value at a specific location. The system 200 may utilize data from the sonar transducer assemblies 102a, 102b, and 102c, as well as other sensors and external data sources such as historical data, community-sourced data, environmental data, or geographic data, to calculate and display the minimum water depth value and maximum water depth value on the marine electronic device 160. The marine electronic device 160 may be used by a user to interact with, view, or otherwise control various aspects of the system 200. In the illustrated embodiment, the marine electronic device 160 is positioned proximate the helm (e.g., steering wheel) of the watercraft 100—although other locations on the watercraft 100 are contemplated. Likewise, additionally or alternatively, a remote device (such as a user's mobile device) may include functionality of a marine electronic device and be a part of the system 200 for determining the minimum water depth value and maximum water depth value.

The system 200 may comprise at least one processor, a memory operatively connected to the at least one processor, and a data retrieval module. The memory may include computer-executable instructions that, when executed by the processor, cause the system to perform various functions, such as receiving user input, determining minimum water depth values and maximum water depth values, and presenting information on a display of the marine electronic device 160. The processor and memory may be integrated into the marine electronic device 160 or may be separate components that are operatively connected to the marine electronic device 160. The data retrieval module, which is executed by the processor, may be configured to access external data sources to gather relevant data such as historical and community-sourced data, environmental data, geographical data, and sensor data. This data may be used by the system 200 to determine the minimum water depth value and maximum water depth value at a specific location.

The watercraft 100 may also comprise other components within the one or more marine electronic devices 160 or at the helm. In FIG. 1, the watercraft 100 comprises a radar 116, which is mounted at an elevated position (although other positions relative to the watercraft 100 are also contemplated). The watercraft 100 also comprises an AIS transceiver 118, a direction sensor 120, and a camera 122, and these components are each positioned at or near the helm (although other positions relative to the watercraft 100 are also contemplated). Additionally, the watercraft 100 comprises a rudder 110 at the stern of the watercraft 100, and the rudder 110 may be positioned on the watercraft 100 so that the rudder 110 rests in the body of water 101. In other embodiments, some of these components may be integrated into the one or more electronic devices 160 or other devices. Another example device on the watercraft 100 includes a temperature sensor 112 that may be positioned so that it will rest within or outside of the body of water 101. Thus, the temperature sensor 112 may measure the air temperature or the temperature of the body of water 101. Other example devices include a wind sensor, one or more speakers, and various vessel devices/features (e.g., doors, bilge pump, fuel tank, etc.), among other things. Additionally, one or more sensors may be associated with marine devices; for example, a sensor may be provided to detect the position of the primary motor 105, the trolling motor 108, or the rudder 110. A position sensor may also be provided in the marine electronic device 160 or at another location. The position sensor may comprise a global positioning system (GPS), inertial navigation system, such as machined electromagnetic sensor (MEMS), a ring laser gyroscope, or another location detection system. The position sensor can provide location data to the system 200 for determining the minimum water depth value and maximum water depth value at a specific location. Other sensors may also be provided on the watercraft 100, including but not limited to a current sensor, a light sensor, a wind sensor, an accelerometer, and a speed sensor. These sensors can provide additional data to the system 200 for determining the minimum water depth value and maximum water depth value, such as wave height, wave activity, current speed and direction, wind speed and direction, and the speed of the watercraft. Other sensors may be provided to measure the pitch of the watercraft, a heave of the watercraft, a sway of the watercraft, a roll of the watercraft, a yaw of the watercraft, a speed of the watercraft, G-forces of the watercraft, acceleration of the watercraft, an autopilot drive activity, a drive load, or a rudder angle. All these sensors and the data they provide can help the system 200 to accurately determine the minimum water depth value and maximum water depth value at a given location. This information is particularly important when considering the challenges faced by watercraft operators while navigating in varying water depths.

There are challenges faced by the operator of the watercraft to navigate safely and efficiently through the body of water 101, despite the constantly changing water levels and depths. Without a system to provide real-time minimum water depth and maximum depth information, the operator must rely on incomplete or outdated data from standard water depth measurements and charts. This can be especially problematic when navigating in unfamiliar waters or during times of heavy wave activity, rapidly changing tides, and/or weather conditions.

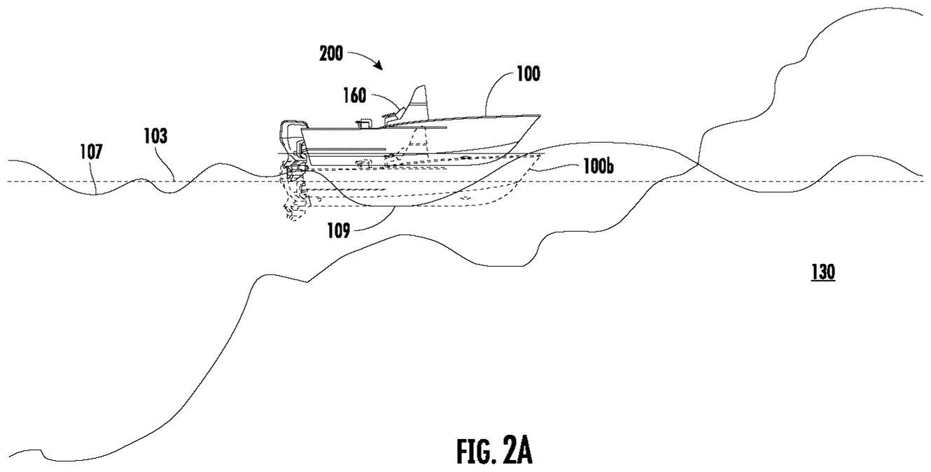

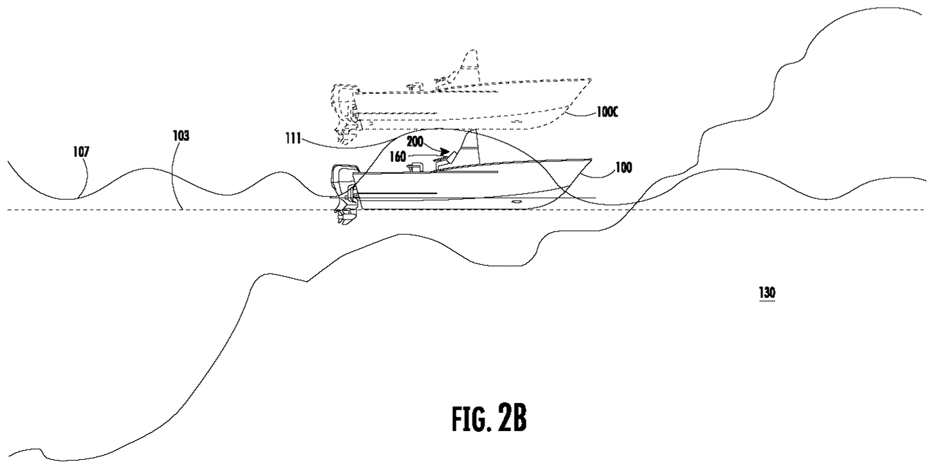

In addition to the safety risks, the lack of accurate minimum water depth information can also lead to inefficient navigation. The operator may need to take longer, more circuitous routes to avoid potential shallow areas, wasting time and fuel. Alternatively, the operator may choose to proceed cautiously and slowly through areas of unknown depth, further reducing the efficiency of the journey. FIG. 2A and FIG. 2B illustrates the challenges faced by operators when navigating a watercraft 100 on a body of water 101 near land 130. As shown in FIG. 2A, the water level and depth of the body of water 101 may vary significantly due to factors such as waves, tides, weather conditions, underwater landscape changes, and other factors which may not be accurately represented in standard water depth measurements or charts. The watercraft 100 illustrates its position at the crest of a wave 107, where, for example, the water level may correspond to the normal water levels 103. At this point, the operator may have a false sense of security, believing that there is sufficient water depth beneath the watercraft 100. However, as the watercraft 100 moves along the waves 107, it may reach a position at the trough of a wave 109, indicated by the watercraft 100b. At this position, the watercraft 100b is at the lowest point on the wave 109, corresponding to the minimum water depth value at that specific location and time. The watercraft 100b at the trough 109 of the wave may be much closer to the land 130 or underwater hazards such as rocks, reefs, or shallow sandbars, than the operator realizes. This lack of accurate and up-to-date information about the minimum water depth value may lead to groundings, collisions, and other accidents.

In contrast, FIG. 2B shows the watercraft 100c at the maximum height or peak of a wave 111, representing the maximum water depth at that location and time compared to the watercraft 100 illustrating its position at the crest of a wave 107, where, for example, the water level may correspond to the normal water levels 103. The system 200 determines the maximum water depth value by analyzing various data sources, including historical and community-sourced data, environmental data, geographical data, and sensor data. In particular, the system 200 considers the water depth value at the location, tide conditions, and wave height data to calculate the maximum water depth. In some embodiments, the system 200 may process the water depth value at the location, tide conditions, and wave height data to calculate the maximum water depth value and to generate a visual guidance. This visual guidance may be a suggested anchor line length for one or more locations on the body of water, which may be displayed on the marine electronic device 160. By providing the maximum water depth value and associated visual guidance, the system 200 can help watercraft operators make informed decisions about anchoring, navigation, and safety. For example, when anchoring, the operator may use the suggested anchor line length to ensure that the anchor has sufficient scope to hold the watercraft securely, even at the maximum water depth value.

The system 200 helps to address these challenges and provide watercraft operators with accurate and dynamic minimum water depth and maximum water depth information. The system 200 utilizes a combination of various data sources and processing techniques to gather and analyze relevant information, ultimately generating an accurate estimation of the minimum water depth value and maximum water depth value at the watercraft's current or intended location.

The minimum water depth and maximum water depth information determined by the system 200 may be ultimately displayed on a marine electronic device 160, or on other display devices available on the watercraft 100. The displayed information may include the current maximum water depth value, and the current minimum water depth value for avoiding groundings and collisions with underwater hazards. This real-time minimum water depth value and maximum water depth value may be continuously updated based on the latest calculations of sensor readings and data from external sources such as historical and community-sourced data, environmental data, or geographic data, providing the operator with an accurate picture of the water depth beneath their watercraft at any given moment.

In addition to the current minimum water depth value and maximum water depth value, the system 200 may also display historical trends and patterns in the water depth data. This information may help the operator understand how the water depth has changed over time at their specific location, allowing them to identify any potential issues or areas of concern. For example, if the historical data shows a consistent pattern of decreasing water depth in a particular area, the operator may choose to avoid that region or navigate through it with extra caution.

The system 200 may also highlight potential hazards or shallow areas in the vicinity of the watercraft 100. This could include marking known underwater obstacles, such as rocks, reefs, or shipwrecks, on the display of the marine electronic device 160. By presenting this information visually, the system helps the operator maintain a safe distance from these hazards and plan their route accordingly.

In addition to depth-related information, the system 200 may also display other relevant data that can impact safe navigation. For example, the system may show the current speed and direction of the watercraft, as well as the speed and direction of any currents or tides in the area. This information can help the operator adjust their course and speed to compensate for these factors and maintain control of the watercraft.

The system 200 may also provide warnings and alerts to the operator when the minimum water depth value falls below a certain threshold or when the watercraft is approaching a known hazard. These alerts can be visual, audible, or both, depending on the operator's preferences and the severity of the situation. For instance, if the system detects that the minimum water depth value is rapidly decreasing and approaching a critical level, it may sound an alarm and display a prominent warning message on the marine electronic device 160, prompting the operator to take immediate action to avoid grounding or collision.

The marine electronic device 160 may also allow the operator to customize the display of the minimum water depth and maximum water depth information to suit their individual needs and preferences. For example, the operator may choose to have the depth values displayed in a particular unit of measurement, or they may opt to have the depth represented visually using color-coded bands or contour lines on a chart or map.

By presenting this information in a clear, intuitive, and customizable manner, the system 200 enables watercraft operators to make informed decisions and take appropriate actions to ensure safe navigation. The operator can quickly and easily access the data they need to assess the current situation, anticipate potential hazards, and plan their route accordingly.

In some embodiments, the system 200 may rely on onboard sensors installed on the watercraft 100 to collect real-time data related to water depth and watercraft movement. These sensors may include sonar transducers, depth sounders, and water level sensors, which directly measure the water depth beneath and around the watercraft. Additionally, motion sensors such as accelerometers and gyroscopes can provide data on the watercraft's position, orientation, and movement (pitch, heave, roll, yaw, speed, and acceleration). By continuously monitoring and processing this sensor data, the system 200 can detect sudden changes in minimum water depth value and maximum water depth value, identify the minimum water depth value and maximum water depth value encountered during a specific time period, and estimate the minimum water depth values and maximum water depth values at the watercraft's current location.

In some embodiments, the system 200 may incorporate historical and community-sourced data to enhance the accuracy and reliability of its minimum water depth value and maximum water depth value estimations. This data may include past water depth measurements, tide tables, and user-reported observations, which can be accessed from external databases via a communication interface. By comparing the current sensor data with historical records and community-sourced information, the system can identify patterns, anomalies, and long-term trends in water depth fluctuations. This enables the system 200 to provide proper minimum water depth value and maximum water depth value estimations, taking into account factors such as, for example, seasonal variations, tidal cycles, and known underwater features.

In some embodiments, the system 200 may also utilize environmental data to refine its minimum water depth value and maximum water depth value estimations. The system 200 may incorporate weather data, such as forecasts, wind speed and direction, and precipitation data, obtained from weather stations, meteorological agencies, or other watercrafts equipped with weather sensors. By analyzing the impact of weather conditions on water levels and wave heights, the system can adjust its minimum water depth value and maximum water depth value estimations accordingly. For example, if the weather data indicates strong winds or high waves, the system may factor in the potential for increased wave heights and lower troughs, resulting in a more conservative estimate of the minimum water depth value and maximum water depth value to ensure safe navigation.

In some embodiments, the system 200 may incorporate geographical data, such as bathymetric maps, topographic data, and information about underwater features, into minimum water depth value estimations. The system 200 may utilize this data to identify areas with known shallow waters, submerged obstacles, or rapid changes in underwater terrain. By combining the geographical data with real-time sensor measurements and other data sources, the system may provide more accurate and location-specific minimum water depth value estimations. This may be particularly valuable when navigating in unfamiliar or poorly charted waters, where relying solely on onboard sensors may not provide a complete picture of the underwater landscape.

In some embodiments, the system 200 may establish a mesh network with other nearby watercraft, wherein the real-time exchange of water depth measurements and other relevant data may significantly enhance the accuracy of the minimum water depth value and maximum water depth value estimations. By sharing and aggregating data from multiple watercrafts in the vicinity, the system can create a more comprehensive and up-to-date understanding of the water depth conditions in the area. This collaborative approach may be beneficial in remote areas or challenging environments where individual watercrafts may have limited sensing capabilities or incomplete data.

The mesh network can be formed using various wireless communication technologies, such as Bluetooth Low Energy (BLE), Wi-Fi, or VHF Data Exchange System (VDES), allowing watercrafts to communicate directly with each other without relying on external infrastructure. The system 200 can intelligently prioritize and integrate data received from other watercrafts based on factors such as proximity, data quality, and timeliness. By continuously updating and refining its minimum water depth value and maximum water depth value estimations based on the collective intelligence of the mesh network, the system can provide watercraft operators with reliable information.

To further enhance the accuracy and adaptability of the minimum water depth value and maximum water depth value estimations, the system 200 may employ advanced data processing techniques, such as machine learning and artificial intelligence algorithms. These algorithms can analyze the vast amount of data collected from various sources, identify complex patterns and relationships, and learn from past experiences to improve their predictive capabilities over time. For example, a machine learning model can be trained on historical data to predict the minimum water depth value and maximum water depth value based on the current sensor readings, environmental conditions, geographical information, and data from other watercrafts. As new data becomes available, the model can be continuously updated and fine-tuned, enabling its ability to provide accurate and reliable estimations in a wide range of scenarios.

The system 200 may also utilize data fusion techniques to intelligently combine and prioritize data from multiple sources. By assigning different weights and confidence levels to each data source based on its reliability, relevance, and timeliness, the system can generate an accurate estimation of the minimum water depth value and maximum water depth value. For instance, the system may give higher priority to real-time sensor data and nearby watercraft observations when estimating the current minimum water depth value and maximum water depth value, while using historical data and geographical information to provide context and long-term trends.

As the actual water depth experienced by the watercraft may vary significantly from standard water depth measurements or charts, the system 200 utilizes a combination of sensors, historical and community sourced data, environmental data, geographical data, collaborative data exchange with other watercrafts, and other external data sources to provide an accurate and dynamic estimation of the minimum water depth values and maximum water depth values. By employing advanced data processing techniques, such as artificial intelligence and machine learning, and enabling communication through mesh networks, the system 200 offers a comprehensive and reliable solution for watercraft operators, enhancing safety and efficiency in various marine environments.

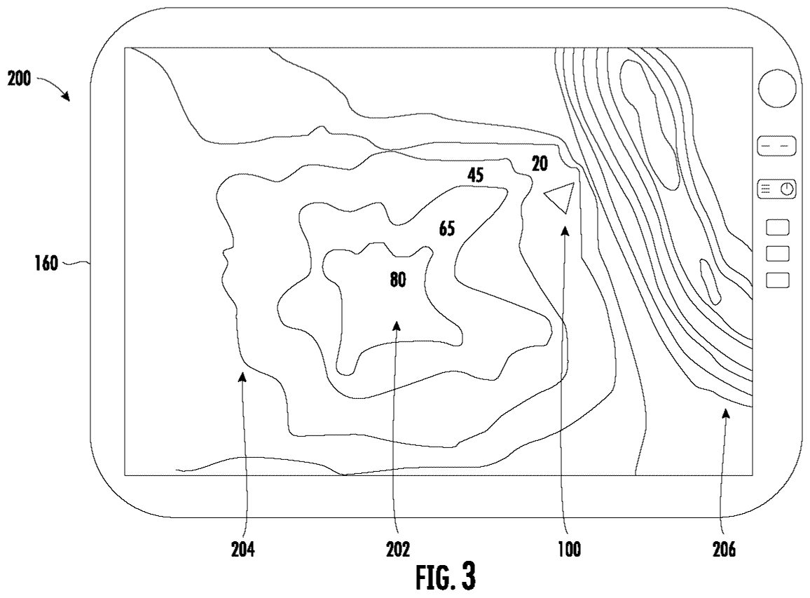

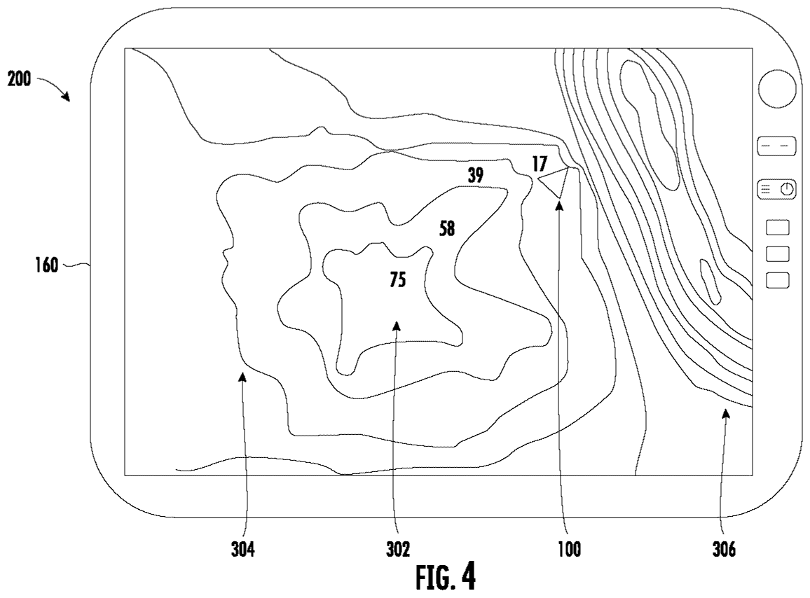

Referring now to FIG. 3 and FIG. 4, schematic views of example map data is illustrated on a marine electronic device 160, which is part of the system 200 for determining minimum water depth values. The system 200 may utilize the marine electronic device 160 as a user interface to present the map data, including contour lines that represent the underwater topography and indicate the water depth at various locations within the body of water. The marine electronic device 160 serves as an interface for users to access and interact with the system 200. Its intuitive and customizable display presents the information generated by the system in a clear and easily understandable format. Users can input their preferences, plans, and queries through the device's user interface, which may include touch screens, physical buttons, or voice commands, depending on the specific implementation.

FIG. 3 illustrates an example of map data displayed on the marine electronic device 160, showing regular water depth values at various locations. These regular water depth values represent the average or typical water depths, providing a general understanding of the underwater topography. The map data is divided into different depth areas, each represented by the different contour lines. The large depth areas 202 correspond to the deepest parts of the body of water, where the water depth is significantly higher than the surrounding areas. The medium depth areas 204 represent the intermediate water depths, which are shallower than the large depth areas but deeper than the shallow depth areas. The shallow depth areas 206 indicate the shallowest parts of the body of water, typically located closer to the shoreline or near underwater features such as reefs, sandbars, or submerged obstacles. The regular water depth values displayed in FIG. 3 are often based on historical data, charts, and surveys conducted during specific conditions, such as mean sea level or average tidal conditions. These values provide a useful reference for navigation planning and can help watercraft operators identify areas that are generally safe to navigate through, based on their watercraft's draft and other characteristics. However, it is important to note that these regular water depth values may not always reflect the actual minimum water depth value at a given location, as they do not account for real-time changes in water level due to factors such as tides, weather conditions, and underwater landscape shifts. To address the limitations of regular water depth values and provide watercraft operators with more accurate and reliable information, the system 200 goes beyond the standard approach by determining and displaying minimum water depth values. FIG. 4 illustrates the same map data as shown in FIG. 3, but with the addition of minimum water depth values. The large depth areas 302, medium depth areas 304, and shallow depth areas 306 now represent the lowest water depth expected at each location, taking into account various factors that influence water level fluctuations, such as tides, weather conditions, and underwater landscape changes.

The system 200 determines the minimum water depth values by analyzing data from multiple sources, including historical data, sensor data, tidal predictions, environmental data, geographical data and other relevant information. This comprehensive approach ensures that the minimum water depth values provide a more accurate representation of the underwater topography.

In both FIG. 3 and FIG. 4, the watercraft 100 is presented in the form of a graphical icon such as a triangle but may be presented in the form of other visual markers such as a boat shape. The watercraft 100 is shown navigating towards a shallow depth area 206, 306, where the water depth decreases, as indicated by the closer spacing of the contour lines. The system 200 can utilize this information to provide real-time guidance and alerts to the watercraft operator. For example, if the system detects that the watercraft is heading towards an area with a minimum water depth value that is unsafe for the watercraft's draft, it can suggest alternative routes or provide instructions for the operator to change course. The map data and minimum water depth information may be presented by the system 200 on the marine device 160 in a clear and intuitive manner. The device 160 can present this information in various formats, such as 2D or 3D maps, charts, or graphs, depending on user preferences and the specific capabilities of the device. Additionally, the device 160 can display other relevant information, such as the watercraft's current position, speed, heading, and draft, along with any alerts or warnings generated by the system.

It is important to note that while the shallow depth areas near the shoreline exhibit the most significant changes in water depth, there may be protected areas or coves where the water depth remains relatively constant. These areas are often sheltered from the direct influence of waves, tides, and currents, resulting in more stable water depths. In FIG. 3 and FIG. 4, these protected areas or coves may be represented by consistent shading or contour lines, indicating minimal changes in water depth across the area. For example, a cove surrounded by high cliffs or a protected bay with a narrow entrance may experience less water level fluctuation compared to exposed shorelines. The natural barriers in these areas can reduce the impact of wind, waves, and tidal changes, creating a more stable environment for watercraft navigation. Similarly, inland bodies of water, such as lakes or reservoirs, may have more consistent water depths due to the absence of tidal influences and the controlled inflow and outflow of water.

However, in these seemingly stable areas, water depths can still vary depending on factors such as seasonal changes, precipitation, or human activities like dam releases or water management practices. Additionally, underwater features such as submerged rocks, logs, or other obstacles may not be immediately visible or accounted for in the regular water depth values displayed in FIG. 3. Therefore, referring to the minimum water depth values provided by the system 200, ensures safe navigation even in protected areas or coves. The system's ability to analyze multiple data sources and provide real-time updates on minimum water depth values can help operators make informed decisions and avoid potential hazards, regardless of the apparent stability of the water depth in a particular area.

In some embodiments, the system 200 may generate alerts or warnings based on the minimum water depth values in conjunction with the watercraft's draft and other characteristics. For example, if the system detects that the watercraft 100 is approaching an area where the minimum water depth value is less than a predetermined safety margin or threshold, it can trigger an alert by the system 200. This alert may be visual, audible, or haptic, depending on the capabilities of the device and user preferences. The operator can then take appropriate actions, such as changing course or reducing speed, to ensure safe navigation.

In some embodiments, the system 200 may consider weather conditions when generating alerts or warnings. For instance, if the system receives data indicating strong winds or high waves in the area, it may adjust the minimum water depth value thresholds for triggering alerts. This adjustment accounts for the potential increase in wave height and the corresponding reduction in the actual water depth value experienced by the watercraft. By factoring in weather conditions, the system provides an additional layer of safety and helps the operator make informed decisions based on the prevailing circumstances.

In some embodiments, the system 200 may use the minimum water depth values to generate safe navigation routes, considering the watercraft's draft, weather conditions, and other relevant factors. By analyzing the minimum water depth values along potential routes, the system can suggest a path that minimizes the risk of grounding or collision with underwater obstacles. This feature may be particularly useful when navigating in unfamiliar waters or when the operator is not experienced in interpreting bathymetric data.

The system 200 enhances the functionality of the marine electronic device by providing more accurate and safety-oriented minimum water depth values, considering various factors that influence water level fluctuations. Through the generation of alerts, warnings, and safe navigation routes based on the minimum water depth values, weather conditions, and watercraft characteristics, the system 200 enables watercraft operators to make informed decisions and navigate safely, particularly in challenging environments such as shallow waters or areas with rapidly changing underwater topography.

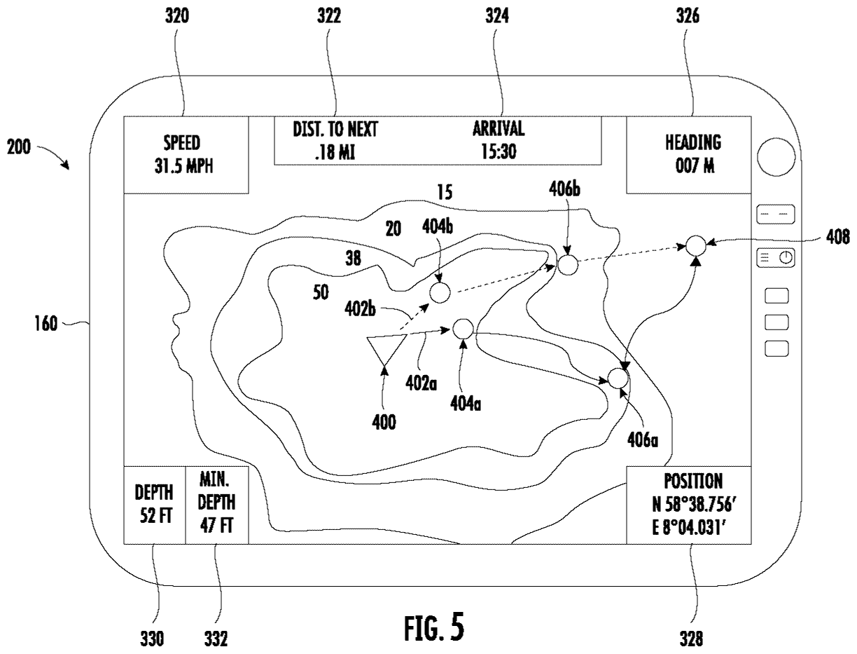

FIG. 5 illustrates an example embodiment of the system 200 displaying a potential route for a watercraft 100 navigating through a body of water on a marine electronic device 160. The system 200 utilizes the map data, including the contour lines and water depth information, as discussed in FIG. 3 and FIG. 4, to provide visual feedback and guidance to the user.

The system 200 may be presented on a customizable display that can be tailored to the user's preferences and needs. In the depicted example of FIG. 5, the system displays data such as the watercraft's current speed 320, distance to the next waypoint 322, estimated arrival time 324, heading 326, and position coordinates 328. Additionally, the system may display the current water depth value 330 and the minimum water depth value 332 at the watercraft's location. The customizable nature of the display may allow users to configure the information presented to include other relevant data points. For instance, users may choose to display weather conditions, such as wind speed and direction, wave height, maximum water depth values, or tidal information that can be gathered from various external databases and sources.

Moreover, users may opt to display information about nearby points of interest, such as marinas, anchorages, or fuel stations, to aid in planning and decision-making during their journey. The system 200 may access databases containing this information and present it on the marine electronic device 160 in a user-friendly manner, such as using icons or color-coded markers.

As discussed in previous sections, the system 200 may access a wide array of data sources to provide accurate and reliable information for minimum water depth value that can be used to assist in navigation guidance. These data sources include historical and community-sourced data, such as past water depth measurements, tide tables, and user-reported observations, which help the system identify patterns and trends in water depth fluctuations. Additionally, the system incorporates environmental data, including weather forecasts, wind speed and direction, and precipitation data, to account for the impact of these factors on water levels and navigation safety. The system 200 may further incorporate environmental data in the system's decision-making process. The system 200 incorporates real-time weather data, such as wind speed and direction, precipitation, and wave height, to assess the impact of these factors on water depths and navigation safety. For example, strong winds can cause water to pile up in certain areas, increasing the water depth, while low atmospheric pressure can lead to lower water levels. By considering these environmental variables, the system can dynamically adjust its recommendations and alerts to provide the most relevant and up-to-date guidance.

Additionally, the system may factor geographical data, including bathymetric maps, topographic data, and information about underwater features such as reefs or wrecks. This data enables the system to create detailed models of the underwater terrain, allowing it to accurately calculate minimum water depth values and identify potential hazards along the route. The system may combine the geographical data with sensor data, such as sonar readings, to provide a precise and reliable representation of the underwater environment.

Moreover, the system may incorporate sensor data from the watercraft's onboard instruments, such as GPS, sonar, and depth sounders, to continuously feed into the system 200, enabling it to monitor the watercraft's position, speed, and surrounding minimum water depth values in real-time. This data may help in detecting any deviations from the planned route or changes in water depth that may pose a risk to the watercraft.

In the depicted scenario, the watercraft 100 is shown at a starting location 400, and the user has input a desired destination 408. The system 200 analyzes the available data from the mentioned external sources (historical and community-sourced data, environmental data, geographical data, sensor data, etc.), considering both the regular water depth values and the minimum water depth values, to suggest potential routes for the watercraft to reach the destination safely.

The system 200 may generate multiple potential routes, such as the two illustrated in FIG. 5: route 402a and route 402b. Route 402b follows a path that passes through location points 404b and 406b. While these points may have sufficient regular water depth values, the system 200 may determine that the minimum water depth values at these locations may be dangerously shallow for the watercraft 100, based on its draft and other characteristics.

In contrast, the system 200 suggests route 402a as the preferred route. This path passes through location points 404a and 406a, which the system has determined to have safe minimum water depth values for the watercraft 100. By considering the minimum water depth values, the system 200 ensures that the suggested route minimizes the risk of grounding or collision with underwater features and/or obstacles.

The system 200 may employ various algorithms and data analysis techniques to determine the optimal route, taking into account factors such as the watercraft's draft, historical and community sourced data, environmental data, geographical data, sensor data, and user preferences. The system may assign different weights to each parameter, prioritizing some factors over others based on their relative importance. For instance, the system may give the highest priority to the safety of the route, which is primarily determined by the minimum water depth values along the path. This means that the system will place a greater emphasis on ensuring that the chosen route maintains a sufficient water depth throughout the journey, minimizing the risk of the watercraft encountering dangerously shallow areas.

However, the system 200 may also take into account other parameters, such as the total distance of the route and the estimated travel time. While safety remains the top priority, the system may also optimize these factors to ensure an efficient journey. For example, if two potential routes have similar minimum water depth values and are both deemed safe, the system may choose the route with the shorter distance or the faster estimated travel time, as this can save fuel and reduce the overall duration of the trip.

By assigning appropriate weights to each parameter, the system can make intelligent trade-offs between safety and efficiency when determining the optimal route. The specific weights assigned to each factor may vary depending on the user's preferences, the characteristics of the watercraft, and the nature of the journey. For instance, a user may prioritize a shorter travel time over a slightly safer route if they are confident in their watercraft's ability to handle shallower waters, or if they are navigating in an area with generally sufficient water depths.

As the watercraft 100 navigates along the suggested route, the system 200 continuously monitors the real-time data from the onboard sensors and external sources (historical and community source data, environmental data, geographical data, sensor data, etc.). If the system detects a change in the minimum water depth value that renders the current route unsafe, it can promptly generate an alert on the marine electronic device 160. This alert may include visual, audible, and haptic feedback to ensure that the user is immediately aware of the potential hazard.

These alerts can be presented on the marine electronic device 160 in various forms, such as pop-up messages, color-coded indicators, or voice prompts, depending on user preferences and the criticality of the situation. For instance, if the system detects that the minimum water depth value along the planned route has decreased to a level that poses a risk to the watercraft, it can display a prominent warning message on the screen, accompanied by an audible alarm to draw the user's attention. The warning message may include details about the location of the shallow area, the current minimum water depth value, and recommendations for alternative actions, such as changing course or reducing speed. The system 200 can provide visual and audible alerts when the minimum water depth value falls below a predefined threshold or when there is a significant change in the water depth that may impact the safety of the watercraft.

In response to the alert, the user can take appropriate action, such as slowing down, stopping, or requesting an alternative route from the system 200. The system can then recalculate a new safe path based on the updated minimum water depth values, considering the watercraft's current position and the surrounding environmental conditions. This dynamic re-routing capability ensures that the user always has access to the safest possible navigation options, even in rapidly changing situations.

Furthermore, the system 200 may provide proactive warnings and recommendations based on predicted changes in water depth values. By analyzing tidal predictions, weather forecasts, and other relevant data, the system can anticipate potential hazards or areas of concern along the planned route. For example, if the system determines that the minimum water depth value at a particular location will become too shallow for safe passage due to an upcoming low tide, it can notify the user in advance, allowing them to adjust their plans accordingly.

This predictive capability may be beneficial for users planning longer trips or navigating in areas with significant tidal variations. By providing timely and accurate information about future water depth conditions, the system 200 enables users to make informed decisions, such as altering their departure time, modifying their route, or choosing an alternative destination altogether.

In some embodiments, the system 200 may enable users to input their planned travel time, considering factors such as the tidal cycle, weather conditions, and the watercraft's speed. By analyzing this information, the system may provide a more accurate estimation of the minimum water depth values the watercraft will encounter during its journey. For example, if a user intends to travel during a period of low tide, the system 200 can calculate the estimated minimum water depth values along the planned route at the specified time, taking into account the tidal predictions. If the system determines that certain sections of the route may have insufficient minimum water depth values during low tide, it can suggest alternative paths or recommend adjusting the departure time to ensure safe navigation throughout the journey.

In addition to route planning and real-time guidance, the system 200 may provide insights for anchoring and docking maneuvers. When approaching a potential anchorage or docking location, the system can analyze the minimum water depth values in the surrounding area, taking into account factors such as the watercraft's draft, tidal predictions, and weather conditions. Based on this analysis, the system can recommend suitable spots for anchoring or docking, ensuring that the watercraft remains safe and stable even during periods of low tide or adverse weather.

Furthermore, the system 200 may assist users in maintaining a safe distance from underwater hazards, such as reefs, rocks, or shallow areas. By continuously monitoring the minimum water depth values in the vicinity of the watercraft and comparing them with the watercraft's draft and other characteristics, the system can provide timely warnings and guidance to help users avoid potential collisions or groundings.

The continuous monitoring of minimum water depth values by the system 200 may also be beneficial in scenarios beyond navigation. For instance, the system 200 can assist users in planning activities like fishing, diving, or water sports. By providing real-time information about the minimum water depth values in different areas, the system can help users identify suitable locations for their intended activities. For example, if a user is interested in fishing in a specific depth range, the system can highlight areas on the map that meet those criteria based on the current minimum water depth values.

Furthermore, the continuous monitoring of minimum water depth values may help in emergency situations, such as when a watercraft runs aground or collides with an underwater obstacle. In such cases, the system 200 may provide information to help users assess the situation and make informed decisions. By displaying the current minimum water depth value and the surrounding bathymetry, the system can assist users in determining the best course of action, such as identifying the safest direction to navigate to deeper water or the most suitable location to await assistance.

The system 200 may also integrate with other onboard systems and sensors to provide a more comprehensive navigation solution. For instance, by combining minimum water depth value data with information from the watercraft's GPS, speed, and heading sensors, the system can offer advanced features like automatic speed adjustment based on the current water depth, or dynamic route optimization to minimize fuel consumption while ensuring safe navigation.

Moreover, the system 200 can leverage machine learning algorithms to enhance its predictive capabilities and provide more accurate and personalized guidance. By analyzing patterns in historical data, user preferences, and real-time conditions, the system can learn to anticipate potential hazards and offer proactive recommendations to users. For example, if the system detects a recurring pattern of shallow water depths in a particular area during certain tidal conditions, it can automatically suggest alternative routes or timing to users planning trips in that region.

The system 200 may have extensive capabilities to provide comprehensive, data-driven navigation guidance and support. The continuous monitoring and real-time updating of minimum water depth values ensures that users have access to the most accurate and up-to-date information for safe navigation. Through its various features, the system 200 empowers users to make informed decisions and navigate with confidence in diverse situations, from routine navigation and anchoring to emergency response and recreational activities.

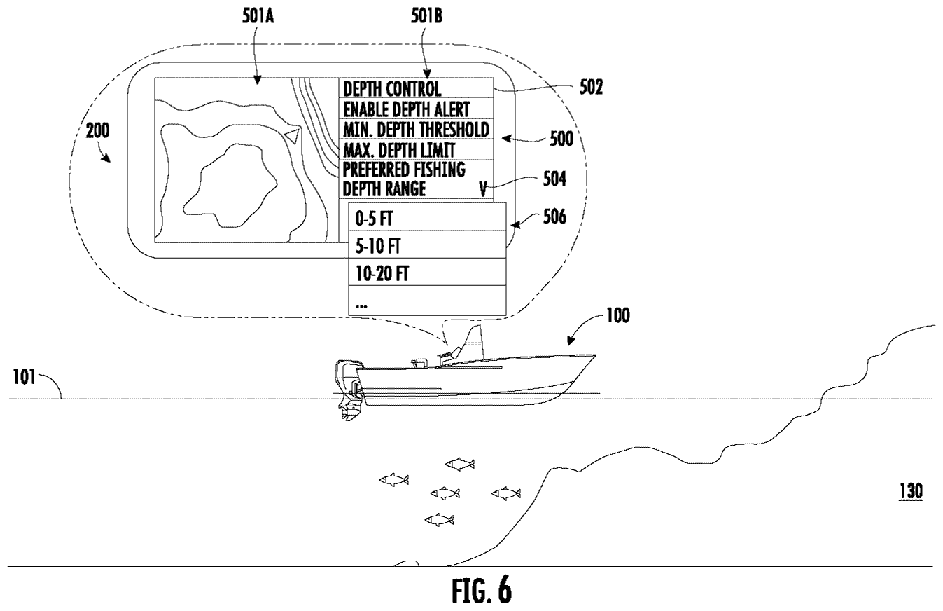

Referring now to FIG. 6, where an example embodiment of the system 200 is illustrated. FIG. 6 features a schematic view of the watercraft 100 on a body of water 101 near land 130, where a further zoomed-in view of a graphical user interface 500 is illustrated on the marine electronic device 160 part of system 200.

The graphical user interface 500 enables users access to a wide range of features and settings tailored to their specific needs and preferences. This may be presented in a split-screen view, with one portion 501A displaying the map data and the current location of the watercraft 100, while the second portion 501B shows the user interface for settings such as depth control settings 502. The split-screen view enables users to simultaneously monitor their position on the body of water 101 and adjust their preferences and settings.

The graphical user interface 500 is designed to be intuitive and user-friendly, with clear icons, labels, and tooltips guiding users through the various features and settings. The split-screen view can be customized to suit individual preferences, allowing users to adjust the size and layout of the map data and settings. The system may also incorporate gesture-based controls or voice commands to further streamline the user interaction.

The depth control settings 502 may provide users with a range of customizable options to enhance their marine experience. The “Preferred Fishing Depth Range” feature 504 may allow users to select their desired water depth range for fishing activities from a drop-down menu 506, which may offer predefined depth ranges and the ability to set custom depth ranges. The system 200 analyzes the available data, including minimum water depth values, maximum water depth values, bathymetric maps, historical records, and real-time sensor data, to identify areas within the body of water 101 that meet the user's specified depth preferences. These areas provide users with optimal fishing locations tailored to their needs. Furthermore, the system 200 offers a wide array of customization options and features to enhance the user's overall marine experience. For example, the user interface 500 may include settings for water temperature preferences. Users can specify their desired temperature range, and the system 200 will identify areas within the body of water 101 that meet those criteria. This feature is particularly useful for fishing enthusiasts targeting specific fish species known to thrive in certain temperature conditions.

To enhance the user experience, the system 200 may employ advanced data analysis and machine learning techniques. By continuously collecting and processing data from various sources, such as onboard sensors, weather stations, and user feedback, the system can refine its recommendations and predictions over time. For example, the system may learn from the user's past fishing successes and preferences to suggest even more targeted fishing locations or techniques.

Furthermore, the system 200 can offer predictive features based on machine learning algorithms. By analyzing patterns and trends in weather data, tidal information, and user behavior, the system can forecast optimal conditions for various marine activities. For example, the system may predict the best times and locations for fishing based on the expected weather patterns, tidal cycles, and fish behavior. These predictions can be displayed on the graphical user interface 500, allowing users to plan their trips accordingly.

In addition to the depth control settings 502, the system 200 may also provide access to various other settings, such as chart settings, enabling users to customize the display of map data and other navigation-related features. In some embodiments, the chart settings may allow users to enable or disable the automatic updating of contour lines on the map based on the minimum water depth values determined by the system 200. When enabled, the contour lines will dynamically adjust to reflect changes in water depth, providing users with a more accurate and up-to-date representation of the underwater topography.

In some embodiments, the chart settings may enable users to activate depth alerts when navigating along a predefined route or of a current or specified location. When this feature is active, the system 200 will monitor the minimum water depth values along the route or the location and provide alerts if the minimum water depth value falls below a user-specified threshold. This helps users avoid potential hazards and maintain safe navigation while following a route or a location.

In some embodiments, the chart settings may also include features such as heading extension and course extension. The heading extension may project a line on the map display, extending from the front of the watercraft icon in the direction of the watercraft's current heading. Users can customize the length and color of the heading extension line to suit their preferences. Similarly, the course extension feature displays a line on the map, representing the watercraft's predicted course over the ground (COG) based on GPS data. Users may enable or disable this feature and customize the length and color of the course extension line. These visual aids help users anticipate the watercraft's path, visualize their actual path of travel, and plan their navigation accordingly.

In some embodiments, the chart settings may provide users with access to various route-related settings, such as the ability to view previous routes, create new routes, and start navigation along a route. These settings allow users to plan and execute their trips efficiently, ensuring they reach their desired destinations safely.

In some embodiments, the system 200 may also provide a logging and recording feature, allowing users to save their favorite fishing spots, calm water areas, anchoring locations, or routes. These saved locations can be easily accessed through the user interface 500. Additionally, users may add notes, photos, or ratings to their saved locations, creating a personalized marine diary.

In addition to its water depth value estimation, the system 200 may offer a comprehensive suite of features designed to enhance the user's overall marine experience. By leveraging the minimum water depth values, maximum water depth values, and other relevant data, the system 200 can assist users in various scenarios, such as fishing, water sports, anchoring, and trip planning.

In some embodiments, the system 200 may focus on assisting users in finding calm waters for various water activities, such as swimming, kayaking, or water skiing. The user interface 500 may provide options for users to define their preferred wave height, wind speed, or current strength. By analyzing weather data, wind forecasts, and water current information, the system 200 can recommend areas that offer the most suitable conditions for the user's chosen activity.

In some embodiments, the system 200 may also provide assistance for anchoring the watercraft 100. When the user activates an anchoring feature through the user interface 500, the system analyzes the minimum water depth values, maximum water depth values, bottom composition, and wind conditions to suggest optimal anchoring locations. The system 200 takes into account factors such as the watercraft's draft, anchor type, and the presence of underwater obstacles to ensure safe and secure anchoring. The maximum water depth value represents the maximum depth the watercraft may encounter at a given location due to tides and waves. By considering the maximum water depth, the system can recommend an appropriate anchor line length in one or more locations to ensure that the anchor has sufficient scope to hold the watercraft securely, even at the highest water levels.

The recommended anchoring spots may be displayed on the map data, along with detailed information about the water depth, bottom type, and any potential hazards. Furthermore, a user may select a specific location, and the system 200 can display additional information about that location. This information may include the exact normal water depth value, minimum water depth value, maximum water depth values, bottom composition, water temperature, current strength, and any available reports or information associated with that spot. In addition to displaying map data such as the minimum water depth values and maximum water depth values, the system 200 may also provide visual guidance on the map data, such as a graphical representation of the recommended anchor line length. This visual guidance helps the operator understand how much anchor line to deploy based on the maximum water depth and other factors at a certain location or provide more than one safe anchoring location, ensuring proper anchoring technique and reducing the risk of dragging or losing the anchor. By providing these details, the system enables users to make informed decisions and plan accordingly.

The system 200 provides extensive capabilities in assisting users with a wide range of marine activities, from fishing and water sports to anchoring and trip planning. The graphical user interface 500, with its split-screen view and interchangeable settings, provides a user-friendly and customizable platform for accessing the system's various features and settings. By leveraging advanced data analysis, machine learning techniques, and external data sources, the system offers accurate, reliable, and personalized recommendations to enhance the user's overall marine experience.

### Example System Architecture

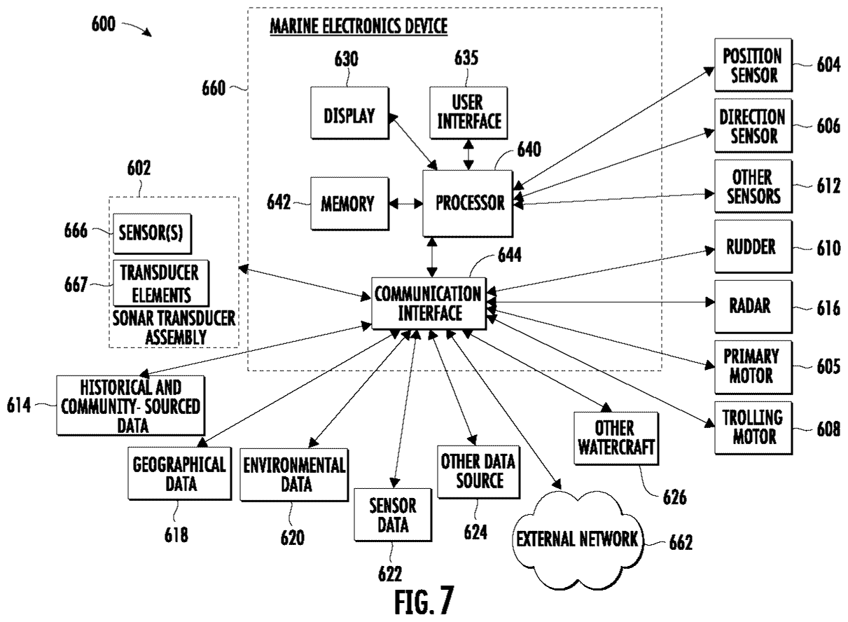

FIG. 7 illustrates a block diagram of an example system 600 according to various embodiments of the present invention described herein. The system 600 advantageously provides for the use of a wide variety of inputs, and these inputs may be utilized to receive data that may be used to assist in the determination of outputs, such as the minimum water depth value and the maximum water depth value at a specific location. This also permits inputs to be provided via several different means, as devices may communicate with a processor 640 within a marine electronic device 660 via a wired connection, a wireless connection, or a connection through an external network.

The illustrated system 600 includes a marine electronic device 660 the system 600 may comprise numerous marine devices. As shown in FIG. 7, one or more sonar transducer assemblies 602 may be provided. A radar 616, a rudder 610, a primary motor 605, and a trolling motor 608 may also be provided as marine devices, but other marine devices may be provided as well. One or more marine devices may be implemented on the marine electronic device 660. For example, a position sensor 604, a direction sensor 606, and other sensors 612 may be provided within the marine electronic device 660. These marine devices can be integrated within the marine electronic device 660, integrated on a watercraft at another location and connected to the marine electronic device 660, and/or the marine devices may be implemented at a remote device in some embodiments. The system 600 may comprise any number of different systems, modules, or components, and each of these may include any device or means embodied in either hardware, software, or a combination of hardware and software configured to perform one or more corresponding functions described herein.

The marine electronic device 660 may include at least one processor 640, a memory 642, the communication interface 644, a user interface 635, a display 630, and one or more sensors (e.g., position sensor 604, direction sensor 606, other sensors 612). One or more of the components of the marine electronic device 660 may be located within a housing or could be separated into multiple different housings (e.g., be remotely located).

The processor(s) 640 may be any means configured to execute various programmed operations or instructions stored in a memory device (e.g., memory 642) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor(s) 640 as described herein. In this regard, the processor(s) 640 may be configured to analyze electrical signals communicated thereto to provide or receive sonar data from one or more sonar transducer assemblies and additional (e.g., secondary) data from other sources. For example, the processor(s) 640 may be configured to receive data from onboard sensors and additional data, determine an expected output value, such as the minimum water depth value, and/or determine a watercraft operation change based on the minimum water depth value.

In some embodiments, the processor(s) 640 may be further configured to implement signal processing. In some embodiments, the processor(s) 640 may be configured to perform enhancement features to improve the display characteristics of data or images, collect or process additional data, such as time, temperature, GPS information, waypoint designations, or others, or may filter extraneous data to better analyze the collected data. The processor(s) 640 may further implement notices and alarms, such as those determined or adjusted by a user, to reflect proximity of other objects (e.g., represented in sonar data), to reflect proximity of other vehicles (e.g., watercraft), approaching storms, or hazardous minimum water depth values etc.

In an example embodiment, the memory 642 may include one or more non-transitory storage or memory devices such as, for example, volatile and/or non-volatile memory that may be either fixed or removable. The memory 642 may be configured to store instructions, computer program code, sonar data, and additional data such as radar data, chart data, location/position data in a non-transitory computer readable medium for use, such as by the processor(s) 640 for enabling the marine electronic device 660 to carry out various functions in accordance with example embodiments of the present invention. For example, the memory 642 could be configured to buffer input data for processing by the processor(s) 640. Additionally, or alternatively, the memory 642 could be configured to store instructions for execution by the processor(s) 640.

The communication interface 644 may be configured to enable communication to external systems (e.g., an external network 662) and configured to retrieve data from various external data sources, such as historical and community-sourced data 614, geographical data 618, environmental data 620, sensor data 622, and other data sources 624. Additionally, the communication interface 644 may be configured to communicate with other watercrafts 626, allowing the system 600 to send and receive information regarding minimum water depth values or other relevant data as needed.

These external data sources may provide additional information that the system 600 can utilize to determine minimum water depth values and maximum water depth values and assist in navigation. Historical and community-sourced data 614 may include previously recorded information about water depths, tides, currents, underwater obstacles, and other relevant factors at specific locations, as well as data gathered from a large group of people through online platforms, mobile applications, or crowdsourcing initiatives. This data can help the system 600 identify trends, patterns, and anomalies in water depth over time. Geographical data 618 may include information about the physical features and characteristics of the Earth's surface, including land masses, water bodies, underwater topography, bathymetric maps, and nautical charts. This data can provide a detailed understanding of the underwater landscape and help the system 600 accurately determine minimum water depth values. Environmental data 620 encompasses information about current and forecasted weather conditions, such as wind speed and direction, wave height, tidal patterns, and precipitation, as well as other environmental factors that can impact marine navigation and affect water depth. Sensor data 622 refers to the information collected by various sensors installed on the watercraft or the marine electronic device, such as GPS receivers, sonar transducers, radar units, speed sensors, orientation sensors, water temperature sensors, and depth sounders. This data can provide real-time measurements of various parameters that influence water depth and navigation. Other data sources 624 may include a wide variety of additional information, such as data from nautical almanacs, tide tables, marine traffic services, user preferences and settings, and historical trip logs.

In this manner, the marine electronic device 660 may retrieve stored data from historical and community-sourced data 614, geographical data 618, environmental data 620, sensor data 622, or other data sources 624 via the external network 662 in addition to or as an alternative to the onboard memory 642. Additionally, or alternatively, the marine electronic device 660 may transmit or receive data, such as sonar signal data, sonar return data, sonar image data, or the like to or from a sonar transducer assembly 602. In some embodiments, the marine electronic device 660 may also be configured to communicate with other devices or systems (such as through the external network 662 or through other communication networks, such as described herein). For example, the marine electronic device 660 may communicate with another system. Using the external network 662, the marine electronic device may communicate with and send and receive data with external sources such as a cloud. The marine electronic device may send and receive various types of data. For example, the system may receive weather data, data from other fish locator applications, alert data, etc. However, this data is not required to be communicated using external network 662, and the data may instead be communicated using other approaches, such as through a physical or wireless connection via the communications interface 644.

The communications interface 644 of the marine electronic device 660 may also include one or more communications modules configured to communicate with one another in any of a number of different manners including, for example, via a network. In this regard, the communications interface 644 may include any of a number of different communication backbones or frameworks including, for example, Ethernet, the NMEA 2000 framework, GPS, cellular, Wi-Fi, Bluetooth, Bluetooth Low Energy (“BLE”) or other suitable networks. The network may also support other data sources, including GPS, engine data, compass, radar, etc. In this regard, numerous other peripheral devices (including other marine electronic devices or sonar transducer assemblies) may be included in the system 600.

The position sensor 604 may be configured to determine the current position and/or location of the marine electronic device 660 (and/or the watercraft 100 (see FIG. 1A)). For example, the position sensor 604 may comprise a GPS, bottom contour, inertial navigation system, such as machined electromagnetic sensor (MEMS), a ring laser gyroscope, or other location detection system. Alternatively, or in addition to determining the location of the marine electronic device 660 or the watercraft 100, the position sensor 604 may also be configured to determine the position and/or orientation of an object outside of the watercraft 100.

The display 630 (e.g., one or more screens) may be configured to present images and may include or otherwise be in communication with a user interface 635 configured to receive input from a user. The display 630 may be, for example, a conventional LCD (liquid crystal display), a touch screen display, mobile device, or any other suitable display known in the art upon which images may be displayed.

In some embodiments, the display 630 may present one or more sets of data (or images generated from the one or more sets of data). Such data includes chart data, radar data, sonar data, weather data, location data, position data, orientation data, sonar data, minimum water depth values, or any other type of information relevant to the watercraft. Sonar data may be received from one or more sonar transducer assemblies 602 or from sonar devices positioned at other locations, such as remote from the watercraft. Additional data may be received from marine devices such as a radar 616, a primary motor 605 or an associated sensor, a trolling motor 608 or an associated sensor, a position sensor 604, a direction sensor 606, other sensors 612, onboard memory 642 (e.g., stored chart data, historical data, etc.), or other devices.

In some further embodiments, various sets of data, referred to above, may be superimposed or overlaid onto one another. For example, a route representation may be applied to (or overlaid onto) a chart (e.g., a map or navigational chart). Additionally, or alternatively, depth information, minimum water depth values, maximum water depth values, weather information, radar information, sonar information, or any other navigation system inputs may be applied to one another.

The user interface 635 may include, for example, a keyboard, keypad, function keys, mouse, scrolling device, input/output ports, touch screen, or any other mechanism by which a user may interface with the system.

Although the display 630 of FIG. 7 is shown as being directly connected to the processor(s) 640 and within the marine electronic device 660, the display 630 could alternatively be remote from the processor(s) 640 and/or marine electronic device 660. Likewise, in some embodiments, the position sensor 604 and/or user interface 635 could be remote from the marine electronic device 660.

The marine electronic device 660 may include one or more other sensors/devices 612, such as configured to measure or sense various other conditions. The other sensors/devices 612 may include, for example, an air temperature sensor, a water temperature sensor, a current sensor, a light sensor, an accelerometer, a wind sensor, a speed sensor, or the like.

The sonar transducer assembly 602 illustrated in FIG. 7 may include one or more sonar transducer elements 667, such as may be arranged to operate alone or in one or more transducer arrays. In some embodiments, additional separate sonar transducer elements (arranged to operate alone, in an array, or otherwise) may be included. As indicated herein, the sonar transducer assembly 602 may also include a sonar signal processor or other processor (although not shown) configured to perform various sonar processing. In some embodiments, the processor (e.g., at least one processor 640 in the marine electronic device 660, a controller (or processor portion) in the sonar transducer assembly 602, or combinations thereof) may be configured to filter sonar return data and/or selectively control transducer element(s) 667. For example, various processing devices (e.g., a multiplexer, a spectrum analyzer, A-to-D converter, etc.) may be utilized in determining minimum water depth values or maximum water depth values or controlling or filtering sonar return data and/or transmission of sonar signals from the transducer element(s) 667.

The sonar transducer assembly 602 may also include one or more other systems, such as various sensor(s) 666. For example, the sonar transducer assembly 602 may include an orientation sensor, such as gyroscope or other orientation sensor (e.g., accelerometer, MEMS, etc.) that can be configured to determine the relative orientation of the sonar transducer assembly 602 and/or the one or more sonar transducer element(s) 667—such as with respect to a forward direction of the watercraft. In some embodiments, additionally or alternatively, other types of sensor(s) are contemplated, such as, for example, a water temperature sensor, a current sensor, a light sensor, a wind sensor, an accelerometer, a speed sensor, or the like.

The components presented in FIG. 7 may be rearranged to alter the connections between components. For example, in some embodiments, a marine device outside of the marine electronic device 660, such as the radar 616, may be directly connected to the processor(s) 640 rather than being connected to the communication interface 644. Additionally, sensors and devices implemented within the marine electronic device 660 may be directly connected to the communications interface in some embodiments rather than being directly connected to the processor(s) 640.

### Example Flowchart(s) and Operation

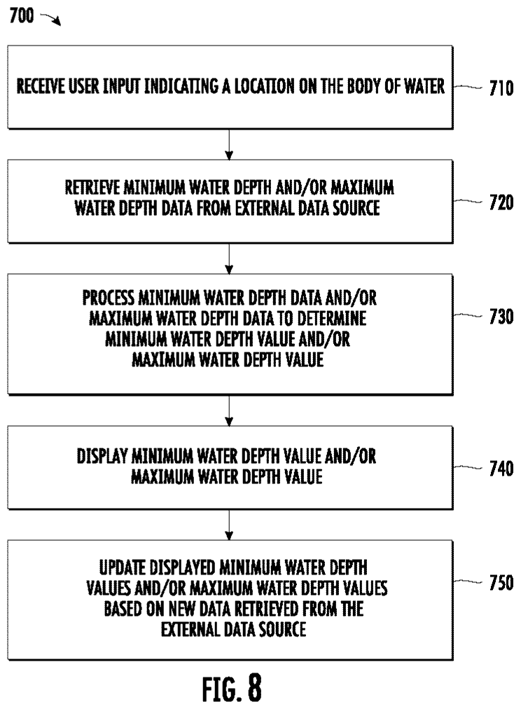

FIG. 8 illustrates a flow chart according to an example method 700 for determining a minimum water depth value and a maximum water depth value at a location on a body of water, in accordance with some embodiments discussed herein. Various types of information may be received and processed to determine and display the minimum water depth value and maximum water depth value. The method 700 may be performed by a system such as the system 200 described in previous figures, utilizing the marine electronic device 160 and its associated components.

At operation 710, user input indicating a location on the body of water is received. The user may input a specific location of interest using various means, such as entering coordinates, selecting a point on a map displayed on the marine electronic device 160, or using a cursor or touchscreen to indicate the desired location. In some embodiments, the user's current location may be automatically determined using a GPS or other positioning system integrated with the marine electronic device 160. Additionally, the user may input parameters such as a desired time or date for which the minimum water depth value and/or maximum water depth value is to be determined, allowing for advanced planning and route optimization.

At operation 720, minimum water depth data and/or maximum water depth data is retrieved from an external data source. The system may access various external data sources, such as historical and community-sourced data, which may include past water depth measurements, tidal patterns, and user-reported observations. Geographical data, such as detailed bathymetric maps and information about underwater features, may also be retrieved. Environmental data, including weather forecasts and real-time sensor data, can be accessed to account for current conditions that may affect water depth. Sensor data from various onboard sensors, such as sonar transducers and depth sounders, may also be utilized.

At operation 730, the retrieved minimum water depth data and/or maximum water depth data is processed to determine the minimum water depth value and/or maximum water depth value at the specified location. The system may employ various algorithms and data analysis techniques to integrate and interpret the data from multiple sources. For example, machine learning algorithms may be used to identify patterns and relationships in the data, enabling the system to generate accurate predictions and estimates of the minimum water depth value and/or maximum water depth value. The system may also consider the specific characteristics of the watercraft, such as its draft and any user-defined safety thresholds, when processing the data to ensure that the minimum water depth value and/or maximum water depth value is relevant and applicable to the user's needs.

At operation 740, the determined minimum water depth value and/or maximum water depth value is displayed on a marine electronic device such as the marine electronic device 160 described in previous figures. The minimum water depth value and/or maximum water depth value may be presented in various formats, such as a numerical value, a color-coded indicator, or a graphical representation on a map or chart. In some embodiments, the system may also display additional information alongside the minimum water depth value and/or maximum water depth value, such as the time and date for which the value was determined, the data sources used in the calculation, and any associated uncertainties or confidence levels.

At operation 750, the displayed minimum water depth value and/or maximum water depth value is updated based on new data retrieved from the external data sources. The system may continuously or periodically retrieve updated data from the external sources to ensure that the displayed minimum water depth value remains accurate and current. For example, if new environmental data indicates a change in tidal conditions or weather patterns, the system may recalculate the minimum water depth value and/or maximum water depth value and update the display accordingly. In some embodiments, the system may also provide alerts or notifications to the user if the updated minimum water depth value falls below a certain threshold or if there is a significant change from the previously displayed value.

The method 700 may also include additional operations or variations based on user preferences or specific use cases. For example, the system may allow users to set custom alerts or notifications based on their desired minimum water depth value thresholds, ensuring that they are informed of any potential hazards or changes in conditions. Additionally, the system may provide route planning and optimization features, using the minimum water depth values to suggest safe and efficient navigation paths between two or more locations.

In another embodiment, the system may utilize the minimum water depth values to provide real-time guidance and assistance during navigation. For example, if the system detects that the watercraft is approaching an area with a low minimum water depth value, it may provide visual or audible warnings to the user, suggesting alternative routes or actions to ensure safe passage.

Furthermore, the system may store and analyze the minimum water depth values and maximum water depth values over time, creating a historical database of water depth information for various locations. This database can be used to identify long-term trends, seasonal patterns, and other insights that may be valuable for marine navigation, research, or environmental monitoring purposes.

Method 700 of FIG. 8 is merely exemplary, and the method 700 may be modified in various ways. For example, the order of operations of the method 700 may differ in other embodiments, and some of the operations of method 700 may be performed simultaneously in some embodiments. Furthermore, additional operations may be added to method 700 and certain operations may be omitted from method 700 in some embodiments.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for determining a minimum water depth at a location on a body of water, the system comprising:
at least one processor;
a display; and
a memory operatively connected to the at least one processor, the memory comprising computer executable instructions that, when executed by the at least one processor, causes the processor to:
receive user input indicating a location on the body of water;
determine a water depth value associated with the location;
determine a minimum water depth value for the location based at least in part on one or more of: historical data and community-sourced data, environmental data, geographical data, or sensor data; and
cause, on the display, presentation of the minimum water depth value.

2. The system of claim 1, further comprising a data retrieval module executed by the processor, wherein the data retrieval module is configured to access external data sources to gather at least one of: the historical data and community-sourced data, the environmental data, the geographical data, or the sensor data.

3. The system of claim 1, wherein the computer executable instructions further cause the processor to:
receive user input specifying a starting location and a destination location;
determine a minimum route depth;
determine a potential route that is optimized for safe navigation based on the minimum water depth value between the starting location and the destination location;
cause presentation of the potential route.

4. The system of claim 3, wherein determining the potential route comprises:
accessing data associated with the potential route from one or more external data sources;
analyzing the accessed data to determine a set of minimum water depth values corresponding to the potential route;
comparing the set of minimum water depth values to the minimum route depth; and
selecting the potential route based on the comparison indicating that the set of minimum water depth values meets the minimum route depth.

5. The system of claim 4, wherein the computer executable instructions further cause the processor to:
monitor the minimum water depth value at locations along the potential route over time;
generate an alert when the minimum water depth value falls below the minimum route depth; and
cause, on the display, presentation of the alert.

6. The system of claim 1, wherein causing presentation of the minimum water depth value on the display comprises rendering a graphical representation of the body of water with the location indicated and presenting the minimum water depth value in association with the location.

7. The system of claim 1, wherein the computer executable instructions further cause the processor to:
continuously monitor for updates to the minimum water depth value for the location; and
adjust the presentation of the minimum water depth value on the display as updated values are received.

8. The system of claim 1, wherein the historical data and community-sourced data comprises aggregated water depth data derived from a plurality of measurements recorded at a location over time.

9. The system of claim 1, wherein the environmental data comprises data representing one or more environmental factors that influence water depth at the location.

10. The system of claim 1, wherein the geographical data comprises data representing physical characteristics of the body of water and surrounding areas.

11. The system of claim 1, wherein the sensor data comprises a plurality of depth related measurements obtained from one or more sensors.

12. A marine electronic device configured to determine and display a minimum water depth at a location on a body of water, the marine electronic device comprising:
at least one processor;
a display; and
a memory operatively connected to the at least one processor, the memory comprising computer executable instructions that, when executed by the at least one processor, cause the processor to:
receive user input indicating a location on the body of water;
determine a water depth value associated with the location;
determine a minimum water depth value for the location based at least in part on one or more of: historical data and community-sourced data, environmental data, geographical data, or sensor data; and
cause, on the display, presentation of the water depth value and the minimum water depth value.

13. The marine electronic device of claim 12, wherein the at least one processor is configured to access external data sources to gather at least one of: the historical and community-sourced data, the environmental data, the geographical data, or the sensor data.

14. The marine electronic device of claim 12, wherein the computer executable instructions further cause the processor to:
receive user input specifying a starting location, wherein the location is a destination location;
determine a minimum route depth corresponding to a potential route between the starting location and the destination location;
determine the potential route based on the minimum water depth value at locations between the starting location and the destination location;
cause, on the display, presentation of the potential route.

15. The marine electronic device of claim 14, wherein determining the potential route comprises:
determining a set of minimum water depth values corresponding to the potential route;
comparing the set of minimum water depth values to the minimum route depth; and
selecting the potential route based on the comparison indicating that the set of minimum water depth values meets the minimum route depth.

16. The marine electronic device of claim 15, wherein the computer executable instructions further cause the processor to:
monitor the minimum water depth value at locations along the potential route over time;
generate an alert when the minimum water depth value falls below the minimum route depth; and
cause, on the display, presentation of the alert.

17. The marine electronic device of claim 12, wherein causing presentation of the minimum water depth value on the display comprises rendering a graphical representation of the body of water with the location indicated and presenting the minimum water depth value in association with the location.

18. The marine electronic device of claim 12, wherein the computer executable instructions further cause the processor to:
continuously monitor for updates to the minimum water depth value for the location; and
adjust the presentation of the minimum water depth value on the display as updated values are determined.

19. A method for determining a minimum water depth at a location on a body of water, the method comprising:
receiving, by at least one processor, user input indicating a location on the body of water;
retrieving, by a data retrieval module executed by the at least one processor, data from one or more external data sources;
determining, by at least one processor, a minimum water depth value for the location based at least in part on data retrieved from the one or more external data sources by the data retrieval module;
causing, by the at least one processor, a display to present the minimum water depth value; and
updating, by the at least one processor, the displayed minimum water depth value based on the data retrieved from the one or more external data sources.

20. The method of claim 19, wherein the data retrieval module is configured to access the one or more external data sources to gather at least one of: historical data and community-sourced data, environmental data, geographical data, or sensor data.

21.-25. (canceled)
